(19) United States
(12) Patent Application Publication
(10) Pub. No.: US 2025/0201439 A1
(43) Pub. Date: Jun. 19, 2025

(54) STRETCHABLE COMPOSITE ELECTRODE AND METHOD OF PREPARING THE SAME

(71) Applicant: POSTECH RESEARCH AND BUSINESS DEVELOPMENT FOUNDATION, Pohang-si (KR)

(72) Inventors: Unyong JEONG, Pohang-si (KR); Hyeongseok CHOI, Pohang-si (KR)

(73) Assignee: POSTECH RESEARCH AND BUSINESS DEVELOPMENT FOUNDATION, Pohang-si (KR)

(21) Appl. No.: 18/891,241

(22) Filed: Sep. 20, 2024

(30) Foreign Application Priority Data
Dec. 13, 2023 (KR) 10-2023-0180544

(51) Int. Cl. H01B 5/14; G01K 7/00

(52) U.S. Cl. CPC H01B 5/14; G01K 7/00

(57) ABSTRACT

A stretchable composite electrode and a method of preparing the same are provided. The stretchable composite electrode includes an ion-gel layer, an upper electrode layer disposed on a top surface of the ion-gel layer, and a lower electrode layer disposed on a bottom surface of the ion-gel layer, wherein each of the upper electrode layer and the lower electrode layer includes a double layer, and a cracked metal layer.

### CROSS-REFERENCE TO RELATED APPLICATION

This application claims the benefit of Korean Patent Application No. 10-2023-0180544, filed on Dec. 13, 2023, in the Korean Intellectual Property Office, the entire disclosure of which is incorporated herein by reference for all purposes.

### BACKGROUND

### 1. Field of the Invention

One or more embodiments relate to a stretchable composite electrode and a method of preparing the stretchable composite electrode.

### 2. Description of the Related Art

When artificial electronic skins are developed in fields such as healthcare or robotics, electrolyte-based systems (ion gels or ionic gels) are widely used and are based on inherent characteristics of electrolytes and characteristics at electrolyte-electrode interfaces. When characteristics of electrolytes or characteristics of electrode interfaces change due to external stimuli, such change appears as a change in electrical signals. In addition, various biocompatible synthetic electrodes are being developed to develop neural electrodes for analyzing biological signals in human bodies. To stably maintain characteristics of electrodes despite large or small mechanical movements of organ tissues, a stretching-insensitive electrode model needs to be implemented.

Due to electrical characteristics of electrolyte-based artificial electronic skins, it is difficult to reliably recognize various types of external stimuli at the same time. For example, when a temperature stimulus and a mechanical stretching stimulus are simultaneously applied, ionic resistance components change due to both the temperature stimulus and the mechanical stretching stimulus, and accordingly, a complex signal processing method such as separating of measurement frequencies is required. Conventional technologies that developed stretching-insensitive nerve electrodes introduced a complex hierarchical structure to minimize effects of mechanical stimuli. Because the complexity of the structure is disadvantageous for application to all microstructures, it is necessary to have the structure as simple as possible.

The above description is information the inventor(s) acquired during the course of conceiving the present disclosure, or already possessed at the time, and is not necessarily art publicly known before the present application was filed.

### SUMMARY

One or more embodiments provide a stretchable composite electrode and a method of preparing the stretchable composite electrode that may control a stretching reactivity of the entire electrolyte system using a composite electrode with a simple structure and that may maintain a stable conductivity even when stretching is applied to an electrode.

However, goals to be achieved by the present disclosure are not limited to those described above, and other goals not mentioned above can be clearly understood by one of ordinary skill in the art from the following description.

According to an aspect, there is provided a stretchable composite electrode including an ion-gel layer, an upper electrode layer disposed on a top surface of the ion-gel layer, and a lower electrode layer disposed on a bottom surface of the ion-gel layer, wherein each of the upper electrode layer and the lower electrode layer includes a double layer, and a cracked metal

In an embodiment, the ion-gel layer may include a mixture of an ionic liquid and a polymer binder.

In an embodiment, the ionic liquid may include at least one of 1-ethyl-3-methylimidazolium bis (trifluoromethylsulfonyl) imide ([EMIM][TFSI]), 1-butyl-3-methylimidazolium bis(trifluoromethylsulfonyl) imide ([BMIM][TFSI]), 1-butyl-3-methylimidazolium hexafluorophosphate ([BMIM][PF₆]), 1-ethyl-3-methylimidazolium tetrafluoroborate ([EMIM][BF₄]), 1-butyl-3-methylimidazolium tetrafluoroborate ([BMIM][BF₄]), 1-butyl-1-methylpyrrolidinium bis(trifluoromethylsulfonyl)imide ([BMPYR][TFSI]), 1-butyl-1-methylpyrrolidinium tris(pentafluoroethyl)trifluorophosphate ([BMPYR][FAP]), 1-ethyl-3-methylimidazolium tris(pentafluoroethyl)trifluorophosphate ([EMIM][FAP]), 1-ethyl-3-methylimidazolium bis(fluorosulfonyl)imide ([EMIM][FSI]), and ethyl-dimethyl-propylammonium bis(trifluoromethylsulfonyl)imide ([EDMPA][TFSI]).

In an embodiment, the polymer binder may include at least one of poly(vinylidene fluoride-co-hexafluoropropylene) (PVDF-HFP), poly(styrene-block-ethylene oxide-block-styrene) (PS-PEO-PS), and poly(styrene-block-methyl methacrylate-block-styrene) (PS-PMMA-PS).

In an embodiment, the double layer of each of the upper electrode layer and the lower electrode layer may include a first metal particle/polymer layer and a second metal particle/polymer layer.

In an embodiment, the first metal particle and the second metal particle may each have a diameter of 5 micrometers (μm) to 20 μm.

In an embodiment, the first metal particle and the second metal particle may each include at least one of gold (Au), silver (Ag), platinum (Pt), palladium (Pd), copper (Cu), cobalt (Co), zirconium (Zr), zinc (Zn), titanium (Ti), and tin (Sn).

In an embodiment, the first metal particle of the upper electrode layer may be in an amount of 75% by weight (wt %) to 80 wt % in the first metal particle/polymer layer, and the second metal particle of the upper electrode layer may be in an amount of 67 wt % to 80 wt % in the second metal particle/polymer layer.

In an embodiment, the first metal particle of the lower electrode layer may be in an amount of 75 wt % to 80 wt % in the first metal particle/polymer layer, and the second metal particle of the lower electrode layer may be in an amount of 67 wt % to 80 wt % in the second metal particle/polymer layer.

In an embodiment, the polymer layer may include at least one of polydimethylsiloxane (PDMS), styrene-ethylene-butylene-styrene (SEBS) block copolymer rubber, styrene-isoprene-styrene (SIS) block copolymer rubber, styrene-butadiene-styrene (SBS) block copolymer rubber, polyisoprene rubber, styrene-butadiene (SB) block copolymer rubber, styrene-isoprene (SI) block copolymer rubber, styrene-isoprene-butadiene-styrene (SIBS) block copolymer rubber, styrene-ethylene-propylene-styrene (SEPS) block copolymer rubber, and styrene-ethylene-propylene (SEP) block copolymer rubber.

In an embodiment, as the amount of the first metal particle and the amount of the second metal particle increase, a thickness of the cracked metal layer may increase.

In an embodiment, the cracked metal layer may include at least one of gold (Au), silver (Ag), platinum (Pt), palladium (Pd), copper (Cu), cobalt (Co), zirconium (Zr), zinc (Zn), titanium (Ti), and tin (Sn).

In an embodiment, the cracked metal layer may have a thickness of 45 nanometers (nm) to 100 nm.

In an embodiment, each of the upper electrode layer and the lower electrode layer may further include an elastic substrate.

In an embodiment, the elastic substrate of each of the upper electrode layer and the lower electrode layer may include at least one of polydimethylsiloxane (PDMS), a fluoroelastomer, a poly(vinylidene fluoride-co-hexafluoropropylene) copolymer, thermosetting polyurethane, silicone, Ecoflex, and Dragon skin.

In an embodiment, when an amount of metal particles in the first metal particle/polymer layer is less than 75 wt %, the stretchable composite electrode may have an impedance of 10⁶ ohms (Ω) to 10⁷ Ω in a frequency range of 10⁰ hertz (Hz) to 10² Hz. When the amount of the metal particles in the first metal particle/polymer layer is greater than or equal to 75 wt % and less than or equal to 80 wt %, the impedance of 10⁶ Ω to 10Ω may be maintained in the frequency range of 10⁰ Hz to 10² Hz. When the amount of the metal particles in the first metal particle/polymer layer exceeds 80 wt %, the impedance may be in a range of 10⁶ Ω to 10⁹ Ω in the frequency range of 10⁰ Hz to 10² Hz.

In an embodiment, when a strain of 10% to 60% is obtained in a strain-positive response and a strain-negative response, a variation in an impedance of the stretchable composite electrode may be similar to a strain-neutral change in a frequency range of 10⁰ Hz to 10⁶ Hz.

According to another aspect, there is provided a method of preparing a stretchable composite electrode, the method including preparing an upper electrode layer and a lower electrode layer, forming an ion-gel layer on each of the upper electrode layer and the lower electrode layer, and arranging the ion-gel layer of the upper electrode layer and the ion-gel layer of the lower electrode layer to face each other and performing a heat treatment.

In an embodiment, the preparing of the upper electrode layer and the lower electrode layer may include forming a sacrificial layer on a substrate, forming a double layer after placing a pattern mask on the sacrificial layer, heat-treating the double layer after removing the pattern mask, coating the heat-treated double layer with an elastic polymer, forming an elastic substrate by curing the elastic polymer, separating the substrate by removing the sacrificial layer, forming a metal layer on the double layer, and forming a crack in the metal layer by stretching the metal layer.

In an embodiment, the forming of the sacrificial layer on the substrate may include applying at least one solution among polyacrylic acid (PAA), polyvinylpyrrolidone (PVP), dextran, poly(methyl methacrylate) (PMMA), and poly(vinyl alcohol) (PVA) onto the substrate by spin coating, and performing a heat-treatment at a temperature of 80° C. to 150° C. for 10 minutes to 60 minutes, to form the sacrificial layer.

In an embodiment, the forming of the double layer may include forming a first metal particle/polymer layer by applying a first metal particle/polymer ink, obtained by mixing a first metal particle and a polymer, by blade coating, plasma-treating a surface of the first metal particle/polymer layer, and forming a second metal particle/polymer layer by applying a second metal particle/polymer ink, obtained by mixing a second metal particle and a polymer, onto the plasma-treated surface of the first metal particle/polymer layer, by blade coating.

In an embodiment, each of the first metal particle and the second metal particle may include at least one of gold (Au), silver (Ag), platinum (Pt), palladium (Pd), copper (Cu), cobalt (Co), zirconium (Zr), zinc (Zn), titanium (Ti), and tin (Sn). The polymer layer of each of the upper electrode layer and the lower electrode layer may include at least one of polydimethylsiloxane (PDMS), styrene-ethylene-butylene-styrene (SEBS) block copolymer rubber, styrene-isoprene-styrene (SIS) block copolymer rubber, styrene-butadiene-styrene (SBS) block copolymer rubber, polyisoprene rubber, styrene-butadiene (SB) block copolymer rubber, styrene-isoprene (SI) block copolymer rubber, styrene-isoprene-butadiene-styrene (SIBS) block copolymer rubber, styrene-ethylene-propylene-styrene (SEPS) block copolymer rubber, and styrene-ethylene-propylene (SEP) block copolymer rubber.

In an embodiment, the plasma-treating of the surface of the first metal particle/polymer layer may include performing an oxygen plasma treatment in a power range of 80 watts (W) to 120 W at an oxygen flow rate of 30 standard cubic centimeters per minute (sccm) to 50 sccm for 1 second to 300 seconds.

In an embodiment, the heat-treating of the double layer may include heat-treating the double layer under a vacuum condition in a temperature range of 100° C. to 200° C. for 1 hour to 6 hours.

In an embodiment, the separating of the substrate, on which the double layer is formed, may include immersing the substrate in deionized water in a temperature range of 20° C. to 100° C. for 30 minutes to 300 minutes and removing the sacrificial layer, to separate the substrate.

In an embodiment, the forming of the crack in the metal layer by stretching the metal layer may include repeatedly performing 5 to 20 times a pre-process of applying and releasing stretching in a range of 30% to 80% after a deposition of the metal layer.

In an embodiment, the method may further include, after the forming of the crack in the metal layer by stretching the metal layer, forming an elastic substrate on the metal layer with the crack.

In an embodiment, the forming of the elastic substrate may include applying the elastic polymer by spin coating, and performing annealing in a temperature range of 20° C. to 100° C. for 30 minutes to 300 minutes.

According to another aspect, a temperature sensor may include the stretchable composite electrode described above.

Additional aspects of embodiments will be set forth in part in the description which follows and, in part, will be apparent from the description, or may be learned by practice of the disclosure.

According to embodiments, a stretchable composite electrode may simply change a stretching reactivity in various directions by adjusting a composition ratio of metal particles in a double layer with a simple structure. In addition, the stretchable composite electrode may maintain a stable electrode resistance even under 50% stretching and may be insensitive to a stretching stimulus due to the cracked metal layer included therein.

According to embodiments, a stretchable composite electrode may be applied to artificial electronic skins compatible with the Internet of Things (IOT), skin-attachable flexible sensors, electrocardiogram monitoring medical devices, smart wearable devices, bioelectrodes for analysis of nerve stimulation, and electronic skins for robots. In addition, the stretchable composite electrode may be applied to artificial electronic skins, skin-attachable medical devices, biosignal analysis devices, and robot skins in the future.

According to embodiments, by a method of preparing a stretchable composite electrode, a stretchable composite electrode that may have a simple structure and that may maintain a stable conductivity even when a crack occurs due to a stretching stimulus may be prepared.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic cross-sectional view of a stretchable composite electrode according to an embodiment;

FIG. 2A is a flowchart illustrating a method of preparing a stretchable composite electrode according to an embodiment, and FIG. 2B is a flowchart illustrating, in detail, a step of preparing an upper electrode layer and a lower electrode layer in the method of FIG. 2A;

FIGS. 3A to 6B illustrate an influence on an impedance profile by a presence of a cracked gold (Au) film on a composite electrode according to an embodiment;

FIGS. 7A to 10 illustrate strain-neutral temperature sensing performance of a sensor fabricated using a cracked Au film according to an embodiment;

FIGS. 11A to 12B illustrate a direction-discernible shear sensor with two terminals and performance of the direction-discernible shear sensor, according to an embodiment; and

FIGS. 13A and 13B illustrate four-directional shear sensing by stacking two direction- discernible shear sensors according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments with reference to the accompanying drawings, like reference numerals refer to like components and a repeated description related thereto will be omitted. In the description of embodiments, detailed description of well-known related structures or functions will be omitted when it is deemed that such description will cause an ambiguous interpretation of the present disclosure.

In addition, the terms first, second, A, B, (a), and (b) may be used to describe components of the embodiments. These terms are used only for the purpose of discriminating one component from another component, and the nature, the sequences, or the orders of the components are not limited by the terms.

Components included in one embodiment and components having a common function will be described using the same names in other embodiments. Unless otherwise mentioned, the descriptions on the embodiments may be applicable to the following embodiments and thus, duplicated descriptions will be omitted for conciseness.

Hereinafter, a stretchable composite electrode, and a method of preparing the stretchable composite electrode according to an embodiment will be described in detail with reference to embodiments and drawings. However, the present disclosure is not limited to the embodiments and drawings.

A stretchable composite electrode according to an embodiment may include an ion-gel layer, an upper electrode layer disposed on a top surface of the ion-gel layer, and a lower electrode layer disposed on a bottom surface of the ion-gel layer. Each of the upper electrode layer and the lower electrode layer may include a first metal particle/polymer layer, and a second metal particle/polymer layer.

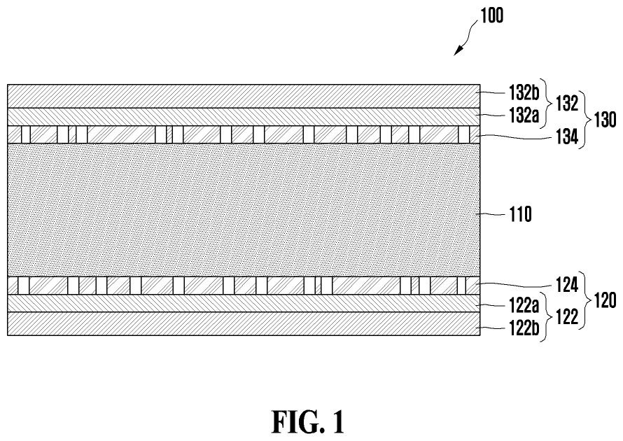

FIG. 1 is a schematic cross-sectional view of a stretchable composite electrode according to an embodiment.

Referring to FIG. 1, a stretchable composite electrode 100 according to an embodiment includes an ion-gel layer 110, a lower electrode layer 120, and an upper electrode layer 130.

In an embodiment, the upper electrode layer 130 and the lower electrode layer 120 may be mirror-symmetrical to each other with respect to the ion-gel layer 110.

The ion-gel layer 110 may be interposed between the upper electrode layer 130 and the lower electrode layer 120 such that the upper electrode layer 130 and the lower electrode layer 120 may face each other. Accordingly, a double layer 122 and a cracked metal layer 124 of the lower electrode layer 120, and a double layer 132 and a cracked metal layer 134 of the upper electrode layer 130 may be symmetrical to each other with respect to the ion-gel layer 110.

In an embodiment, the ion-gel layer 110 may include a mixture of an ionic liquid and a polymer binder. The ionic liquid may be excellent in a chemical stability and may have a broad electrochemical window. The ionic liquid may include cations and anions.

In an embodiment, the ionic liquid may include at least one of 1-ethyl-3-methylimidazolium bis(trifluoromethylsulfonyl)imide ([EMIM][TFSI]), 1-butyl-3-methylimidazolium bis(trifluoromethylsulfonyl)imide ([BMIM][TFSI]), 1-butyl-3-methylimidazolium hexafluorophosphate ([BMIM][PF₆]), 1-ethyl-3-methylimidazolium tetrafluoroborate ([EMIM][BF₄]), 1-butyl-3-methylimidazolium tetrafluoroborate ([BMIM][BF₄]), 1-butyl-1-methylpyrrolidinium bis(trifluoromethylsulfonyl)imide ([BMPYR][TFSI]), 1-butyl-1-methylpyrrolidinium tris(pentafluoroethyl)trifluorophosphate ([BMPYR][FAP]), 1-ethyl-3-methylimidazolium tris(pentafluoroethyl)trifluorophosphate ([EMIM][FAP]), 1-ethyl-3-methylimidazolium bis(fluorosulfonyl)imide ([EMIM][FSI]), and ethyl-dimethyl-propylammonium bis(trifluoromethylsulfonyl)imide ([EDMPA][TFSI]).

Desirably, the ionic liquid may be 1-butyl-3-methylimidazolium bis(trifluoromethylsulfonyl)imide ([BMIM][TFSI]).

The polymer binder may include an ultraviolet ray (UV)-curable polymer that is cured by UV rays. In this case, the polymer binder may be cured as a predetermined photoinitiator is activated by UV rays.

The polymer binder may also include a block copolymer in addition to the UV-curable polymer. The block copolymer may be, for example, a triblock copolymer.

In an embodiment, the polymer binder may include at least one of poly(vinylidene fluoride-co-hexafluoropropylene) (PVDF-HFP), poly(styrene-block-ethylene oxide-block-styrene (PS-PEO-PS), and poly(styrene-block-methyl methacrylate-block-styrene (PS-PMMA-PS).

The polymer binder may be poly(vinylidene fluoride-co-hexafluoropropylene) (PVDF-HFP).

By mixing the ionic liquid and the polymer binder and inducing crosslinking of a binder, a gel-type material including an ionic liquid between crosslinked polymers, that is, an ion-gel, may be obtained. The above ion-gel may have a relatively high dielectric constant. For example, the ion-gel may have a dielectric constant of about “10” or greater.

Accordingly, the ion-gel may have transparency in addition to flexibility and/or stretchability.

In an embodiment, the double layer 122 may include a first metal particle 122a and a polymer layer 122b, and the double layer 132 may include a second metal particle 132a and a polymer layer 132b.

In an embodiment, the first metal particle 122a and the second metal particle 132a may have a diameter of 5 micrometers (μm) to 20 μm; 5 μm to 15 μm; 5 μm to 10 μm; 10 μm to 20 μm; 10 μm to 15 μm; or 15 μm to 20 μm.

When the diameter of the first metal particle 122a and the second metal particle 132a is less than 5 μm, it may be difficult to electrically connect the first metal particle and the second metal particle to a metal layer. When the diameter exceeds 20 μm, a thickness of the first metal particle/polymer layer and the second metal particle/polymer layer may increase.

In an embodiment, the first metal particle 122a and the second metal particle 132a may each include at least one of gold (Au), silver (Ag), platinum (Pt), palladium (Pd), copper (Cu), cobalt (Co), zirconium (Zr), zinc (Zn), titanium (Ti), and tin (Sn).

Desirably, the first metal particle 122a and the second metal particle 132a may be silver (Ag) particles.

In an embodiment, the first metal particle of the upper electrode layer 130 may be in an amount of 75% by weight (wt %) to 80 wt %; or 75 wt % to 78 wt % in the first metal particle/polymer layer.

When the amount of the first metal particle of the upper electrode layer 130 is less than 75 wt % in the first metal particle/polymer layer, an ionic resistance may increase due to stretching, which may have an influence on an electrical signal. When the amount of the first metal particle exceeds 80 wt %, the ionic resistance may decrease due to stretching, and an electrode area may uniformly increase during stretching, which may cause a problem in that a stretching reaction is fixed in one direction.

In an embodiment, the second metal particle of the upper electrode layer 130 may be in an amount of 67 wt % to 80 wt %; 67 wt % to 75 wt %; 67 wt % to 70 wt %; 70 wt % to 80 wt %; 70 wt % to 75 wt %; or 75 wt % to 80 wt % in the second metal particle/polymer layer.

When the amount of the second metal particle of the upper electrode layer 130 is less than 67 wt % in the second metal particle/polymer layer, an electrode resistance may increase due to stretching, which may have an influence on an electrical signal. When the amount of the second metal particle exceeds 80 wt %, a problem in that a corresponding electrode is not properly cured may occur.

In an embodiment, the first metal particle of the lower electrode layer 120 may be in an amount of 75 wt % to 80 wt %; or 75 wt % to 78 wt % in the first metal particle/polymer layer.

When the amount of the first metal particle of the lower electrode layer 120 is less than 75 wt % in the first metal particle/polymer layer, the ionic resistance may increase due to stretching, which may have an influence on an electrical signal. When the amount of the first metal particle exceeds 80 wt %, the ionic resistance may decrease due to stretching, and an electrode area may uniformly increase during stretching, which may cause a problem in that a stretching reaction is fixed in one direction.

In an embodiment, the second metal particle of the lower electrode layer 120 may be in an amount of 67 wt % to 80 wt %; 67 wt % to 75 wt %; 67 wt % to 70 wt %; 70 wt % to 80 wt %; 70 wt % to 75 wt %; or 75 wt % to 80 wt % in the second metal particle/polymer layer.

When the amount of the second metal particle of the lower electrode layer 120 is less than 67 wt % in the second metal particle/polymer layer, the electrode resistance may increase due to stretching, which may have an influence on an electrical signal. When the amount of the second metal particle exceeds 80 wt %, a problem in that a corresponding electrode is not properly cured may occur.

When the first metal particle and the second metal particle satisfy the above ranges, the ionic resistance may hardly change due to the stretching, and accordingly, the reactivity may be ignorable.

In particular, when a sufficiently large number of micro-metal particles is included, the lower electrode layer 120 may function to allow a stable electric resistance to be maintained even when an electrode is stretched. Unlike a related art, the stretchable composite electrode according to an embodiment may control a stretching reactivity of the entire electrolyte system using a composite electrode with a simple structure. In an embodiment, the polymer layer of each of the upper electrode layer and the lower electrode layer may include at least one of polydimethylsiloxane (PDMS), styrene-ethylene-butylene-styrene (SEBS) block copolymer rubber, styrene-isoprene-styrene (SIS) block copolymer rubber, styrene-butadiene-styrene (SBS) block copolymer rubber, polyisoprene rubber, styrene-butadiene (SB) block copolymer rubber, styrene-isoprene (SI) block copolymer rubber, styrene-isoprene-butadiene-styrene (SIBS) block copolymer rubber, styrene-ethylene-propylene-styrene (SEPS) block copolymer rubber, and styrene-ethylene-propylene (SEP) block copolymer rubber.

Desirably, a polymer resin of each of the double layers 122 and 132 may be styrene-isoprene-butadiene-styrene (SIBS) block copolymer rubber, and a polymer resin of each of the cracked metal layers 124 and 134 may be polydimethylsiloxane (PDMS). Since the SIBS block copolymer rubber does not require an annealing process, it is easy to control the stretching reactivity due to a wide numerical range of the amount of metal particles, however, due to a lack of crosslinking, the electrode resistance may quickly increase due to stretching. Although numerical values of the amount of metal particles are limited because the PDMS requires an annealing process, the electrode resistance may not easily change due to stretching because crosslinking is sufficient, so that the PDMS may stably maintain a resistance of a double layer when connected to the lower electrode layer.

The polymer layer 122b of the double layer 122 may be PDMS, and the polymer layer 132b of the double layer 132 may be SIBS block copolymer rubber.

Since the SIBS block copolymer rubber does not require an annealing process, it is easy to control the stretching reactivity due to a wide numerical range of the amount of metal particles, however, due to a lack of crosslinking, the electrode resistance may quickly increase due to stretching. Although numerical values of the amount of metal particles are limited because the PDMS requires an annealing process, the electrode resistance may not easily change due to stretching because crosslinking is sufficient, so that the PDMS may stably maintain a resistance of a double layer when connected to the lower electrode layer.

In an embodiment, the cracked metal layer may include at least one of gold (Au), silver (Ag), platinum (Pt), palladium (Pd), copper (Cu), cobalt (Co), zirconium (Zr), zinc (Zn), titanium (Ti), and tin (Sn).

Desirably, the cracked metal layers 124 and 134 may be Au.

In an embodiment, the cracked metal layer may have a thickness of 45 nanometers (nm) to 100 nm; 45 nm to 80 nm; 45 nm to 60 nm; 60 nm to 100 nm; 60 nm to 80 nm; or 80 nm to 100 nm.

When the thickness of the cracked metal layer is less than 45 nm, a weak stretching reactivity may be exhibited, and when the thickness exceeds 100 nm, there is no advantage in maintaining a conductivity against the cost.

In an embodiment, as the amount of the first metal particle and the amount of the second metal particle increase, the thickness of the cracked metal layer may increase.

An effective electrode area may be dominantly determined by the total area of the cracked metal layer, regardless of the amount of the first metal particle and the amount of the second metal particle, thereby achieving stable insensitivity to stretching.

In an embodiment, each of the upper electrode layer 130 and the lower electrode layer 120 may further include an elastic substrate (not shown).

Each of the upper electrode layer 130 and the lower electrode layer 120 may be allowed to be embedded in the elastic substrate.

In an embodiment, the elastic substrate may include at least one of polydimethylsiloxane (PDMS), a fluoroelastomer, a poly(vinylidene fluoride-co-hexafluoropropylene) copolymer, thermosetting polyurethane, silicone, Ecoflex, and Dragon skin.

Desirably, the elastic substrate may be polydimethylsiloxane (PDMS).

In an embodiment, when an amount of metal particles in the first metal particle/polymer layer is less than 75 wt %, the stretchable composite electrode may have an impedance of 10⁶ ohms (Ω) to 10⁷ Ω in a frequency range of 10⁰ hertz (Hz) to 10² Hz. When the amount of the metal particles in the first metal particle/polymer layer is greater than or equal to 75 wt % and less than or equal to 80 wt %, the impedance of 10⁶ Ω to 10⁷ Ω may be maintained in the frequency range of 10⁰ Hz to 10² Hz. When the amount of the metal particles in the first metal particle/polymer layer exceeds 80 wt %, the impedance may be in a range of 10⁶ Ω to 10⁹ Ω in the frequency range of 10⁰ Hz to 10² Hz.

When the amount of metal particles in the first metal particle/polymer layer is less than 75 wt %, the impedance may decrease, and when the amount of the metal particles in the first metal particle/polymer layer is greater than or equal to 75 wt % and less than or equal to 80 wt %, the electrode resistance may be stably maintained even under stretching. When the amount of the metal particles in the first metal particle/polymer layer exceeds 80 wt %, the impedance may increase.

The stretchable composite electrode according to an embodiment may simply change the stretching reactivity in various directions by adjusting a composition ratio of metal particles in the first metal particle/polymer layer and the second metal particle/polymer layer with a simple structure.

In an embodiment, when a strain is in a range of 10% to 60%; 10% to 50%; 10% to 40%; 10% to 30%; 10% to 20%; 20% to 60%; 20% to 50%; 20% to 40%; 20% to 30%; 30% to 60%; 30% to 50%; 30% to 40%; 40% to 60%; 40% to 50%; or 50% to 60%, in a strain-positive response and a strain-negative response, a variation in an impedance of the stretchable composite electrode may be similar to a strain-neutral change in a frequency range of 10⁰ Hz to 10⁶ Hz.

For example, even at a strain ε of 50%, impedance profiles may remain almost unchanged regardless of the thickness of the metal layer. Thus, it can be confirmed that the cracked metal layer functions as a surface electrode and that exposure of the first metal particle and the second metal particle through the crack of the metal layer is negligible. Impedance spectra may represent a strain-neutrality in the entire frequency range. Thus, it can be found that the impedance does not change due to stretching.

The stretchable composite electrode according to an embodiment may simply change the stretching reactivity in various directions by adjusting a composition ratio of metal particles in a double layer with a simple structure. In addition, the stretchable composite electrode may maintain a stable electrode resistance even under 50% stretching and may be insensitive to a stretching stimulus due to the cracked metal layer included therein.

The stretchable composite electrode according to an embodiment may be applied to artificial electronic skins compatible with the Internet of Things (IOT), skin-attachable flexible sensors, electrocardiogram monitoring medical devices, smart wearable devices, bioelectrodes for analysis of nerve stimulation, and electronic skins for robots. In addition, the stretchable composite electrode may be applied to artificial electronic skins, skin-attachable medical devices, biosignal analysis devices, and robot skins in the future.

A method of preparing a stretchable composite electrode according to an embodiment may include preparing an upper electrode layer and a lower electrode layer, forming an ion-gel layer on each of the upper electrode layer and the lower electrode layer, and arranging the ion-gel layer of the upper electrode layer and the ion-gel layer of the lower electrode layer to face each other and performing a heat treatment.

In an embodiment, the preparing of the upper electrode layer and the lower electrode layer may include forming a sacrificial layer on a substrate, forming a double layer after placing a pattern mask on the sacrificial layer, heat-treating the double layer after removing the pattern mask, coating the heat-treated double layer with an elastic polymer, forming an elastic substrate by curing the elastic polymer, separating the substrate by removing the sacrificial layer, forming a metal layer on the double layer, and forming a crack in the metal layer by stretching the metal layer.

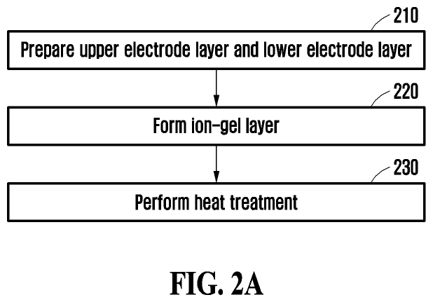

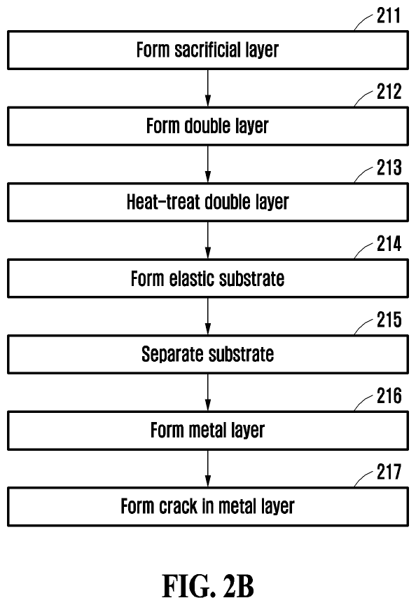

FIG. 2A is a flowchart illustrating a method of preparing a stretchable composite electrode according to an embodiment, and FIG. 2B is a flowchart illustrating, in detail, a step of preparing an upper electrode layer and a lower electrode layer in the method of FIG. 2A.

Referring to FIG. 2A, the method may include step 210 of preparing an upper electrode layer and a lower electrode layer, step 220 of forming an ion-gel layer, and step 230 of performing a heat treatment.

In step 210, the upper electrode layer and the lower electrode layer may be separately prepared.

Referring to FIG. 2B, step 210 may include step 211 of forming a sacrificial layer, step 212 of forming a double layer, step 213 of heat-treating the double layer, step 214 of forming an elastic substrate, step 215 of separating a substrate, step 216 of forming a metal layer, and step 217 of forming a crack in the metal layer.

In step 211, the sacrificial layer may be formed on the substrate.

In an embodiment, the substrate may include at least one of glass, quartz, silicon (Si), silicon oxide (SiO₂), polyethylene terephthalate (PET), polyethylene naphthalate (PEN), polycarbonate (PC), polyethersulfone (PES), polyimide (PI), a cyclic olefin copolymer (COC), and polydimethylsiloxane (PDMS).

In an embodiment, the forming of the sacrificial layer on the substrate may include applying at least one solution among polyacrylic acid (PAA), polyvinylpyrrolidone (PVP), dextran, poly(methyl methacrylate) (PMMA), and poly(vinyl alcohol) (PVA) onto the substrate by spin coating, and performing a heat treatment at a temperature of 80° C. to 150° C.; 80° C. to 130° C.; 80° C. to 110° C.; 80° C. to 90° C.; 100° C. to 150° C.; 100° C. to 130° C.; 100° C. to 110° C.; or 130° C. to 150° C. for 10 minutes (min) to 60 min; 10 min to 40 min; 10 min to 20 min; 20 min to 60 min; 20 min to 40 min; or 40 min to 60 min, to form the sacrificial layer.

Desirably, polyacrylic acid (PAA) may be formed as a sacrificial layer at a temperature of 100° C. to 130° C. for 20 min.

In step 212, a pattern mask may be placed on the sacrificial layer, and the double layer may be formed.

In step 212, the pattern mask may be played on the sacrificial layer, and a first metal particle/polymer layer and a second metal particle/polymer layer may be formed.

In an embodiment, the forming of the double layer may include forming a first metal particle/polymer layer by applying a first metal particle/polymer ink, obtained by mixing a first metal particle and a polymer, by blade coating, plasma-treating a surface of the first metal particle/polymer layer, and forming a second metal particle/polymer layer by applying a second metal particle/polymer ink, obtained by mixing a second metal particle and a polymer, onto the plasma-treated surface of the first metal particle/polymer layer, by blade coating.

In an embodiment, the first metal particle and the second metal particle may each include at least one of gold (Au), silver (Ag), platinum (Pt), palladium (Pd), copper (Cu), cobalt (Co), zirconium (Zr), zinc (Zn), titanium (Ti), and tin (Sn).

Desirably, the first metal particle and the second metal particle may be Ag particles.

In an embodiment, the polymer layer of each of the upper electrode layer and the lower electrode layer may include at least one of polydimethylsiloxane (PDMS), styrene-ethylene-butylene-styrene (SEBS) block copolymer rubber, styrene-isoprene-styrene (SIS) block copolymer rubber, styrene-butadiene-styrene (SBS) block copolymer rubber, polyisoprene rubber, styrene-butadiene (SB) block copolymer rubber, styrene-isoprene (SI) block copolymer rubber, styrene-isoprene-butadiene-styrene (SIBS) block copolymer rubber, styrene-ethylene-propylene-styrene (SEPS) block copolymer rubber, and styrene-ethylene-propylene (SEP) block copolymer rubber.

The polymer layer of the first metal particle/polymer layer may be polydimethylsiloxane (PDMS), and the polymer layer of the second metal particle/polymer layer may be styrene-isoprene-butadiene-styrene (SIBS) block copolymer rubber.

The plasma-treating of the surface may be performed to generate an ultra-homogeneous and ultra-thin second metal particle/polymer layer on the first metal particle/polymer layer.

In an embodiment, the plasma-treating of the surface may include performing an oxygen plasma treatment in a power range of 80 watts (W) to 120 W; 80 W to 110 W; 80 W to 100 W; 80 W to 90 W; 90 W to 120 W; 90 W to 110 W; 90 W to 100 W; 100 W to 120 W; 100 W to 110 W; or 110 W to 120 W at an oxygen flow rate of 30 standard cubic centimeters per minute (sccm) to 50 sccm for 1 second(s) to 300 s; 1 s to 250 s; 1 s to 200 s; 1 s to 150 s; 1 s to 100 s; 1 s to 50 s; 60 s to 300 s; 60 s to 250 s; 60 s to 200 s; 60 s to 150 s; 60 s to 100 s; 100 s to 300 s; 100 s to 250 s; 100 s to 200 s; 100 s to 150 s; 150 s to 300 s; 150 s to 250 s; 150 s to 200 s; 200 s to 300 s; or 200 s to 300 s.

When a plasma treatment according to an embodiment is performed, a remarkably excellent and ultra-homogeneous double layer may be obtained.

In step 213, the pattern mask may be removed, and the double layer may be heat-treated.

In an embodiment, the heat-treating of the double layer may include heat-treating the double layer under a vacuum condition in a temperature range of 100° C. to 200° C.; 100° C. to 180° C.; 100° C. to 150° C.; 100° C. to 130° C.; 130° C. to 200° C.; 130° C. to 180° C.; 130° C. to 150° C.; 150° C. to 200° C.; 150° C. to 180° C.; or 180° C. to 200° C. for 1 hour (h) to 6 h; 1 h to 4 h; 1 h to 2 h; 2 h to 6 h; 2 h to 4 h; or 4 h to 6 h.

In step 214, an elastic polymer may be applied onto the heat-treated double layer and may be cured, to form the elastic substrate.

In an embodiment, the elastic substrate of each of the upper electrode layer and the lower electrode layer may include at least one of polydimethylsiloxane (PDMS), a fluoroelastomer, a poly(vinylidene fluoride-co-hexafluoropropylene) copolymer, thermosetting polyurethane, silicone, Ecoflex, and Dragon skin.

Desirably, the elastic polymer may be polydimethylsiloxane (PDMS).

In an embodiment, the forming of the elastic substrate may include applying the elastic polymer onto the first metal particle/polymer layer and the second metal particle/polymer layer by spin coating, and performing curing in a temperature range of 20° C. to 100° C.; 20° C. to 80° C.; 20° C. to 60° C.; 20° C. to 40° C.; 40° C. to 100° C.; 40° C. to 80° C.; 40° C. to 60° C.; 60° C. to 100° C.; 60° C. to 80° C.; or 80° C. to 100° C. for 30 min to 300 min; 30 min to 240 min; 30 min to 180 min; 30 min to 60 min; 60 min to 300 min; 60 min to 240 min; 60 min to 180 min; 120 min to 300 min; 120 min to 240 min; 120 min to 180 min; 180 min to 300 min; or 180 min to 240 min.

In step 215, the sacrificial layer may be removed, and the substrate, on which the double layer is formed, may be separated.

In an embodiment, the separating of the substrate, on which the double layer is formed, by removing the sacrificial layer may include immersing the substrate in deionized water in a temperature range of 20° C. to 100° C.; 20° C. to 80° C.; 20° C. to 60° C.; 20° C. to 40° C.; 40° C. to 100° C.; 40° C. to 80° C.; 40° C. to 60° C.; 60° C. to 100° C.; 60° C. to 80° C.; or 80° C. to 100° C. for 30 min to 300 min; 30 min to 200 min; 30 min to 100 min; 30 min to 60 min; 60 min to 300 min; 60 min to 200 min; 60 min to 100 min; 120 min to 300 min; 120 min to 200 min; 180 min to 300 min; 180 min to 200 min; or 200 min to 300 min, and removing the sacrificial layer, to separate the substrate.

In step 216, the metal layer may be formed on the double layer.

In an embodiment, the metal layer may include at least one of gold (Au), silver (Ag), platinum (Pt), palladium (Pd), copper (Cu), cobalt (Co), zirconium (Zr), zinc (Zn), titanium (Ti), and tin (Sn).

Desirably, the metal layer may be Au.

The metal layer may be formed using at least one method selected from sputtering, pulsed laser deposition, thermal evaporation, molecular beam epitaxy, and chemical vapor deposition.

In an embodiment, the metal layer may have a thickness of 45 nm to 100 nm; 45 nm to 80 nm; 45 nm to 60 nm; 60 nm to 100 nm; 60 nm to 80 nm; or 80 nm to 100 nm.

Step 217 may further include forming a creak in the metal layer by stretching the metal

The forming of the crack in the metal layer may include, after a deposition of the metal layer, performing a pre-process of applying and releasing stretching in a range of 30% to 80%; 30% to 70%; 30% to 60%; 30% to 50%; 30% to 40%; 40% to 80%; 40% to 70%; 40% to 60%; 40% to 50%; 50% to 80%; 50% to 70%; 50% to 60%; 60% to 80%; 60% to 70%; or 70% to 80%, to a corresponding composite electrode 5 to 20 times; 5 to 15 times; 5 to 10 times; 10 to 20 times; 10 to 15 times; or 15 to 20 times, to provide insensitivity to stretching.

Desirably, the pre-process of applying and releasing stretching in the range of 40% to 60% may be performed 5 to 15 times, to provide the insensitivity to stretching.

For example, after the deposition of the metal layer, a pre-process of applying and releasing 50% stretching to a corresponding composite electrode may be performed 10 times.

A crack may be naturally formed in the metal layer during the deposition of the metal layer, however, embodiments are not limited thereto. For example, a larger number of cracks may also be formed by adding a step of forming a crack.

The stretchable composite electrode according to an embodiment may maintain a stable electrode resistance even under 50% stretching and may be insensitive to a stretching stimulus due to the metal layer with the crack.

In step 220, a mixture of an ionic liquid and a polymer binder may be included in each of the upper electrode layer and the lower electrode layer and may be cured, to form the ion-gel layer.

In an embodiment, the ionic liquid may include at least one of 1-ethyl-3-methylimidazolium bis(trifluoromethylsulfonyl)imide ([EMIM][TFSI]), 1-butyl-3-methylimidazolium bis(trifluoromethylsulfonyl)imide ([BMIM][TFSI]), 1-butyl-3-methylimidazolium hexafluorophosphate ([BMIM][PF6]), 1-ethyl-3-methylimidazolium tetrafluoroborate ([EMIM][BF4]), 1-butyl-3-methylimidazolium tetrafluoroborate ([BMIM][BF4]), 1-butyl-1-methylpyrrolidinium bis(trifluoromethylsulfonyl)imide ([BMPYR][TFSI]), 1-butyl-1-methylpyrrolidinium tris(pentafluoroethyl)trifluorophosphate ([BMPYR][FAP]), 1-ethyl-3-methylimidazolium tris(pentafluoroethyl)trifluorophosphate ([EMIM][FAP]), 1-ethyl-3-methylimidazolium bis(fluorosulfonyl)imide ([EMIM][FSI]), and ethyl-dimethyl-propylammonium bis(trifluoromethylsulfonyl)imide ([EDMPA][TFSI]).

In an embodiment, the polymer binder may include at least one of poly(vinylidene fluoride-co-hexafluoropropylene) (PVDF-HFP), poly(styrene-block-ethylene oxide-block-styrene (PS-PEO-PS), and poly(styrene-block-methyl methacrylate-block-styrene (PS-PMMA-PS).

A mixing weight ratio of the ionic liquid and the polymer binder may be in a range of 1:9 to 3:7. When the mixing weight ratio of the ionic liquid and the polymer binder is less than 1:9, a range of the amount of metal particles that determines the stretching reactivity may change. When the mixing weight ratio of the ionic liquid and the polymer binder exceeds 3:7, excess ionic liquid may be smeared or leak when an ion-gel layer is formed.

Spin coating may be performed on the double layer, in which the mixture of the ionic liquid and the polymer binder is prepared, at a speed of 200 revolutions per minute (rpm) to 500 rpm; 200 rpm to 400 rpm; 200 rpm to 300 rpm; 300 rpm to 500 rpm; 300 rpm to 400 rpm; or 400 rpm to 500 rpm, for 10 s to 60 s; 10 s to 40 s; 10 s to 20 s; 20 s to 60 s; 20 s to 40 s; or 40 s to 60 s, a heat treatment may be performed at 120° C. for 20 min, and a remaining solvent may be dried, to form the ion-gel layer.

In an embodiment, the method may further include, after the forming of the crack in the metal layer by stretching the metal layer, a step of forming an elastic substrate on the metal layer with the crack.

In an embodiment, the forming of the elastic substrate may include applying the elastic polymer by spin coating, and performing annealing in a temperature range of 20° C. to 100° C. for 30 min to 300 min.

In an embodiment, the elastic substrate of each of the upper electrode layer and the lower electrode layer may include at least one of polydimethylsiloxane (PDMS), a fluoroelastomer, a poly(vinylidene fluoride-co-hexafluoropropylene) copolymer, thermosetting polyurethane, silicone, Ecoflex, and Dragon skin.

Desirably, the elastic polymer may be PDMS.

In step 230, the ion-gel layer of the upper electrode layer and the ion-gel layer of the lower electrode layer may be arranged to face each other, and the heat treatment may be performed.

The ion-gel layer may be sandwiched between the upper electrode layer and the lower electrode layer such that the upper electrode layer and the lower electrode layer may be mirror-symmetrical to each other with respect to the ion-gel layer, and heat treatment may be performed.

The heat treatment may be performed at a temperature of 80° C. to 150° C.; 80° C. to 130° C.; 80° C. to 100° C.; 100° C. to 150° C.; 100° C. to 130° C.; or 130° C. to 150° C. for 1 minute to 60 min; 1 minute to 40 min; 1 minute to 20 min; 1 minute to 10 min; 10 min to 60 minutes; 10 minutes to 40 minutes; 10 minutes to 20 minutes; 20 minutes to 60 minutes; 20 minutes to 40 minutes; or 40 minutes to 60 minutes, to prepare a stretchable composite electrode according to an embodiment.

By the method of preparing the stretchable composite electrode according to an embodiment, a stretchable composite electrode that may have a simple structure and that may maintain a stable conductivity even when a crack occurs due to a stretching stimulus may be prepared.

A temperature sensor according to an embodiment may include a stretchable composite electrode manufactured by the method of preparing the stretchable composite electrode according to an embodiment.

Since the stretchable composite electrode is included in the temperature sensor, the temperature sensor may be used as a sensor that is insensitive to a stretching stimulus and in which an impedance does not change during stretching.

Hereinafter, the present disclosure will be described in detail with reference to the following examples. However, the technical idea of the present disclosure is not limited or restricted thereby.

### EXAMPLE

### Materials

Silver flake (with a width of 8 to 10 μm) was purchased from Inframat (US). 2-butanone (MEK) and toluene were purchased from Sigma-Aldrich. Elastic poly(vinylidene fluoride-co-hexafluoropropylene) (e-PVDF-HFP, FC 2181) was purchased from 3M (Dyneon, US). 1-butyl-3-methylimidazolium: bis(trifluoromethylsulfonyl)imide (BMIM: TFSI) was purchased from Sigma-Aldrich. Poly (styrene-block-isobutylene-block-styrene) (SIBS, SIBSTAR) was purchased from Keneka. Poly (dimethylsiloxane) (PDMS, Sylgard 184) was purchased from Dow Corning. Poly (acrylic acid) (PAA, Mw=5000, 50% solution in water) was purchased from Polysciences. Ecoflex 00-10 (part A and part B) and silicon adhesive (Sil-Poxy) were purchased from Smooth-On.

### Preparation of Composite Electrode

A 50 μm-thick poly(ethylene terephthalate) (PET) film was treated by O2 plasma (200 W, 2 min, O₂ gas at 22 sccm). An Ecoflex 00-10 pre-polymer (1:1 ratio of part A and part B) was spin-coated (1500 rpm, 30 s) on the PET film and annealed at 80° C. for 2 h. A patterned stencil (PET/Ecoflex) mask was prepared using a razor cutter (Model: CE6000-40, Graphtec). A width of the patterned lines was 2 millimeters (mm). The PAA solution (1.0 g) was diluted with 9 g of deionized water in a 20 ml vial. The PAA solution was spin-coated (1000 rpm, 30 s) on a washed slide glass and annealed at 120° C. for 20 min. The stencil mask was placed on the slide glass for patterning of an electrode. Ag flakes were added in a SIBS solution (20 wt % in toluene) to prepare various Ag/SIBS inks (φ_{Ag}=0.50, 0.67, 0.75, 0.80, 0.83, 0.86).

Likewise, Ag flakes (1.5 g) were added in a PDMS pre-polymer solution (20:1 ratio of a pre-polymer to a curing agent, 33 wt % in MEK) to prepare Ag/PDMS ink. A weight ratio of the Ag flakes, the pre-polymer solution, and the MEK was 3:1:2. The Ag/SIBS ink was blade-coated on a slide glass and dried at room temperature for 5 min. The Ag/PDMS ink was also blade-coated after treating the Ag/SIBS line with O₂ plasma (100 W, 1 min, O₂ gas 22 sccm). The patterned line was annealed in vacuum at 150° C. for 2 h after removing the mask. The PDMS pre-polymer solution (20:1 ratio of the pre-polymer to the curing agent) was spin-coated (350 rpm, 30 s) thereon and cured at 80° C. for 2 h. The film coated on the slide glass was immersed in deionized water at 80° C. at 1 h to dissolve a PAA film. After peeling it off from the slide glass, the stretchable composite electrode according to an embodiment was prepared.

### Fabrication of Ion-Gel Sensor

Ionic liquid (BMIM: TFSI) was added in an e-PVDF-HFP solution (20 wt % in MEK). A weight ratio of the ionic liquid to the polymer was 1:9. The e-PVDF-HFP solution was spin-coated (300 rpm, 30 s) on a surface of a composite electrode. After annealing at 120° C. for 20 min to dry a solvent, two substrates prepared in the same manner were stacked to face each other and annealed again at 180° C. for 30 min for further crosslinking of an ion-gel film.

### Fabrication of Strain-Neutral Temperature Sensor

The stencil mask was placed on the surface of the composite electrode (φ_{Ag}=0.50) and aligned for line patterns. Au (60 nm) was sputtered through the patterned lines. After peeling of the mask, a process of fabricating the ion-gel sensor was performed to prepare a strain-neutral temperature sensor.

### Fabrication of Direction-Discernable Shear Sensor

A bottom composite electrode was patterned to include two branched lines (φ_{Ag}=0.86 and 0.50) in parallel, and a top composite electrode was patterned to include a single line (φ_{Ag}=0.86). Likewise, the process of fabricating the ion-gel sensor was performed to prepare a direction-discernable shear sensor. The Ecoflex 00-10 pre-polymer (1:1 ratio of part A and part B) was poured into a petri dish (polystyrene, 90 mm×15 mm) and cured at 80° C. for 2 h to prepare a soft floor. To reduce friction between the direction-discernable shear sensor and the soft floor, baby powder was rubbed on an Ecoflex surface and then the direction-discernable shear sensor was placed on the rubbed Ecoflex surface. Edges of the direction-discernable shear sensor were fixed on the Ecoflex floor using Sil-Poxy.

### Measurements

Conductive tapes (Product: ST-610, Daehyun ST, Korea) were connected to a top electrode and a bottom electrode. Liquid metal was pasted to enhance a connection between the conductive tapes and the above electrodes. Impedance spectroscopy was measured with an impedance analyzer (Model: PalmSens4, PalmSens, Netherlands). Alternating current (AC) potential (250 mV) was applied to measure impedance with a frequency range of 0.1 Hz to 1.0

MHz. Strain responses of the ion-gel sensor were observed while using a homemade stretcher. An impedance of a temperature sensor was monitored using an LCR meter (ZM 2376, NF Co.) under AC bias 250 mV at 10³ Hz while the strain was applied using a universal measurement probe (UMP 100, Teraleader Co., Korea). The topological characterization of a surface of an electrode was performed using SEM (TM-1000, Hitachi, Japan) and AFM (Dimension Icon,

Bruker, USA). The electrical characterization of the surface of the electrode was performed using C-AFM (Dimension Icon, Bruker, USA) in a contact mode with a Pt/Ir-coated tip (SCM-PIC-V2, Bruker Nano Inc., USA).

### Strain-Neutral Temperature Sensing

An ion-gel temperature sensor was attached to a skin of a wrist by polyimide (PI) tapes (3M). A temperature was measured from impedance values at a fixed measurement frequency (103 Hz) regardless of whether the wrist was bent. An embodiment of the present disclosure was approved by the Institutional Review Board office at POSTECH Ethics Committee (PIRB-2023-E011).

### Direction-Discernable Shear Sensing

Both a normal force and a shear force were simultaneously applied on a shear sensor using an UMP (Teraleader Co. Korea) with a 5 kgf load cell (Model: HUMMA-K5, HAIAM ENG Co., Korea). To prevent a slip issue during the shear force, a double-sided tape (3M) was attached to a contact surface of the load cell.

### General Route to Strain-Neutrality obtained by Au Deposition and Formation of Crack

The concept of an invariant conductive surface was extended to generate a highly reproducible strain-neutral electrode. A continuous Au film was sputtered on bilayer composite electrodes.

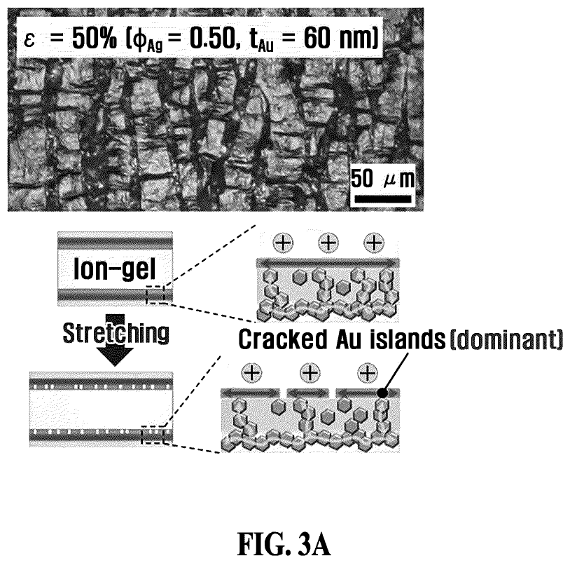

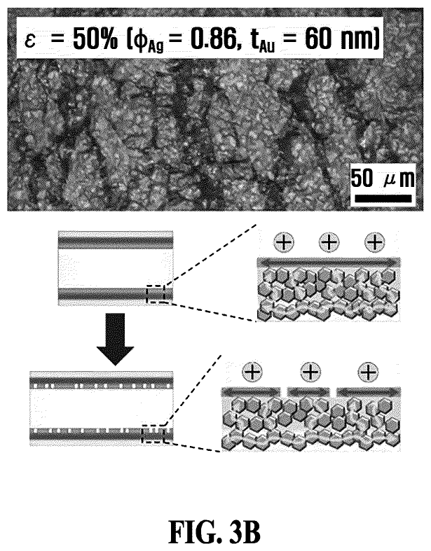

FIGS. 3A to 6B illustrate an influence on an impedance profile by a presence of a cracked Au film on a composite electrode according to an embodiment.

A deposited Au film with various thicknesses (t_{Au}=15, 30, 45, 60 nm) was intentionally cracked by stretching at ε=50% on electrodes with low φ_{Ag}(=0.50, FIG. 3A) and high φ_{Ag}(=0.86, FIG. 3B). The cracked Au islands functioned as electrically-effective surfaces.

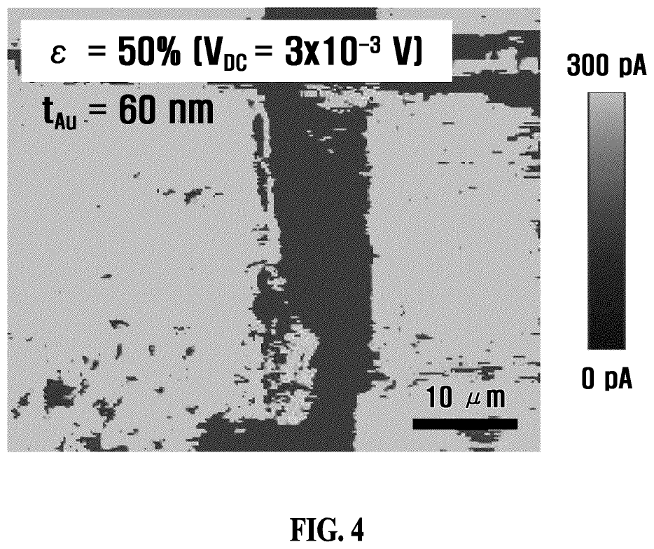

The above strategy is advantageous in that the coverage of an effective surface may be greatly enhanced and there is no tunneling barrier so that a device may properly operate at an extremely low operating voltage, as shown in a C-AFM image obtained at 3×10⁻³ V for t_{Au}=60 nm (FIG. 4 ).

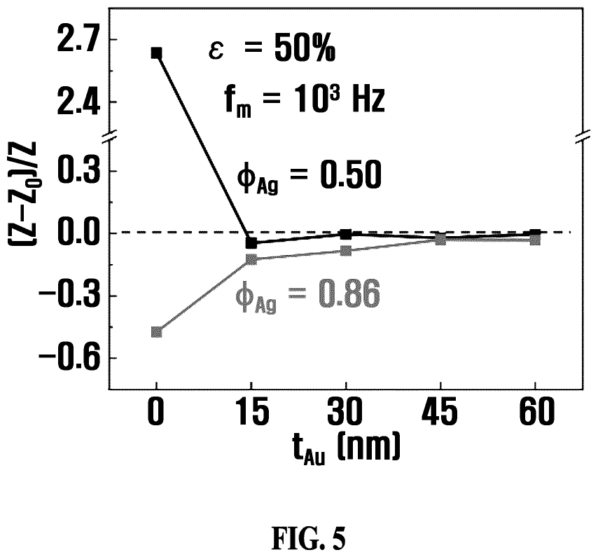

FIG. 5 illustrates a dependence of (Z−Zo)/Zo of an ion-gel sensor on t_{Au}, measured at fₘ=10³ Hz. Two ion-gel sensors were made with electrodes with φ_{Ag}(=0.50 and 0.86) to compare an effect on a strain-positive sensor and a strain-negative sensor. Impedance responses were compared at ε=50%. The result indicates that the cracked Au islands effectively reduced the strain-sensitivity for both a strain-positive electrode and a strain-negative electrode. Impedance profiles were almost invariant when Au was deposited on an electrode with φAg =0.50, regardless of t_{Au}. The above result infers that the cracked Au film functions as a surface electrode and an exposure of the Ag flakes through Au cracks is negligible. Meanwhile, the impedance profiles moved down for an electrode with φ_{Ag}=0.86 when t_{Au}≤30 nm. This is because many cracks are generated due to a thin Au film, thus a highly conductive composite surface is exposed to the air under large stretching. Once t_{Au}>45 nm for the electrode with φ_{Ag}=0.86, a sensor became completely strain-neutral.

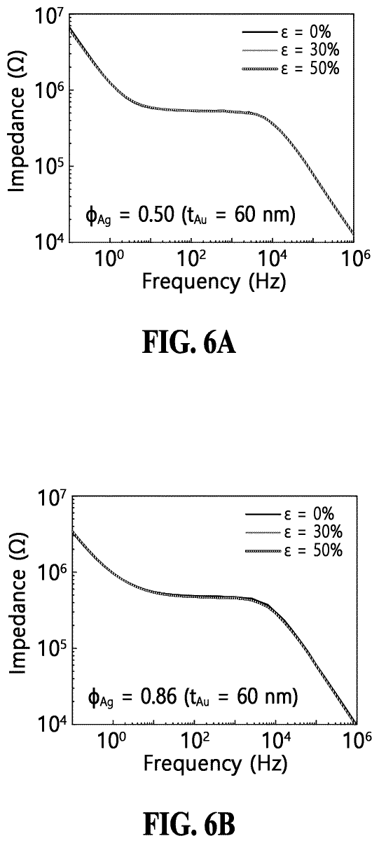

FIGS. 6A and 6B illustrate an impedance spectroscopy under stretching (ε=0, 30, 50%) for t_{Au}=60 nm generated on composite electrodes with φ_{Ag}=0.50 and 0.86 in a strain-neutral ion-gel sensor, respectively. Impedance spectra showed completely strain-neutral in the entire frequency range. Thus, it can be confirmed that no impedance changes due to stretching.

### Strain-Neutral Temperature Sensor

A strain-neutral electrode is a critical element for precise sensing of a temperature. A strain-insensitive temperature sensor was fabricated using an Au crack-based electrode.

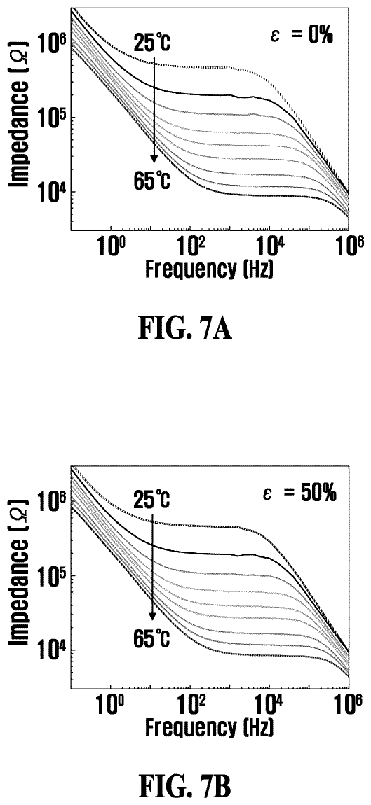

FIGS. 7A to 10 illustrate strain-neutral temperature sensing performance of a sensor fabricated using a cracked Au film according to an embodiment.

As shown in an effect of a temperature in the impedance spectroscopy measured at an initial state (ε=0%) in FIG. 7A, and a stretched state (ε=50%) in FIG. 7B, thermal heating moved downward the flat impedance line (dominated by Rᵢₒₙ) due to enhanced kinetic energy of ions. A temperature dependence of the sensor was compared at a temperature of 25 to 65° C. The sensor showed identical impedance spectroscopy at corresponding temperatures at ε=0% and ε=50. In (Z) was insensitive to strain according to a temperature at a fixed fₘ(=10³ Hz).

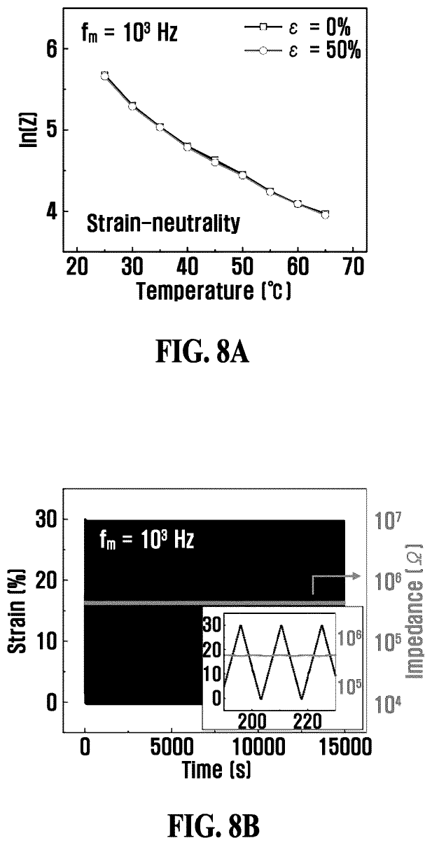

Strain-insensitive temperature sensing by an ion-gel sensor required real-time measurements at two discrete frequencies to decouple temperature and deformation. In addition, a charge relaxation frequency (τ⁻¹) needs to be used as an intrinsic variable to monitor a heat effect. However, in an embodiment, a strain-neutral sensor required only one measurement frequency (=103 Hz) and allowed use of impedance instead of the relaxation time (FIG. 8A) because the electrode itself was completely strain-neutral. Due to the above advantage, the system was simplified and data processing was easily performed. A strain-neutral temperature sensor was fabricated by sputtering Au (t_{Au}=60 nm) on the composite electrode with φ_{Ag}=0.50 based on FIG. 6A. Impedance-temperature curves at ε=0% and ε=50% were in excellent overlap in a calibration curve (R²=0.9994). The impedance of the sensor did not change during “1000” repeated stretching cycles at ε=30% (FIG. 8B).

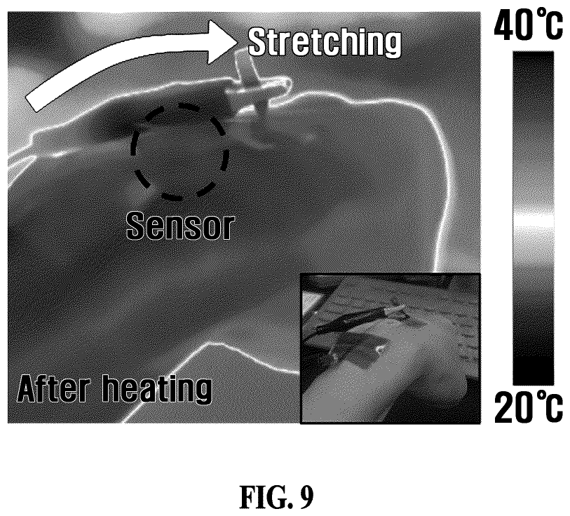

FIG. 9 illustrates an infrared (IR) camera image of a temperature sensor attached to a wrist after heating a stretched region by a hair dryer of an ion-gel sensor according to an embodiment. The temperature sensor was attached to the wrist and temperatures before and after heating by the hair dryer were monitored. The temperatures was monitored at a normal state and a stretched state by bending the wrist, which provided identical temperature values.

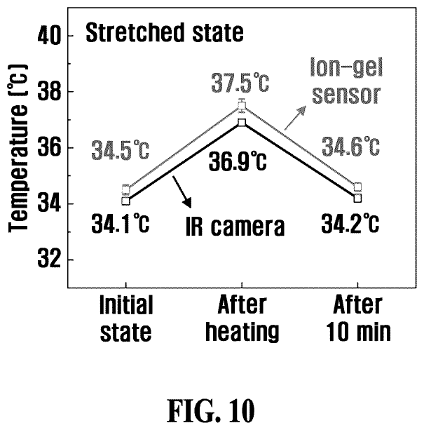

The temperatures measured with the ion-gel sensor were compared to those measured with IR camera images. FIG. 10 illustrates changes in temperature before and after heating the stretched region by the ion-gel sensor and an IR camera according to an embodiment. Temperatures measured from an impedance and IR images matched each other and were maintained by about 0.4° C. or higher using an ion-gel temperature sensor.

### Direction-Discernible Shear Sensing by Combining Strain-Positive Ion-Gel Sensor and Strain-Negative Ion-Gel Sensor

Purposive managing of a strain-positive response and a strain-negative response may provide a unique possibility such as recognizing of a shear direction in a simple device structure.

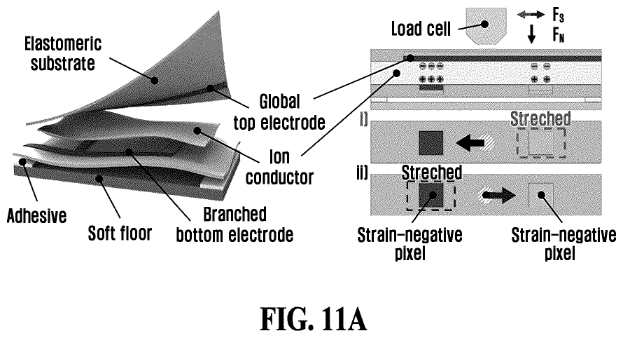

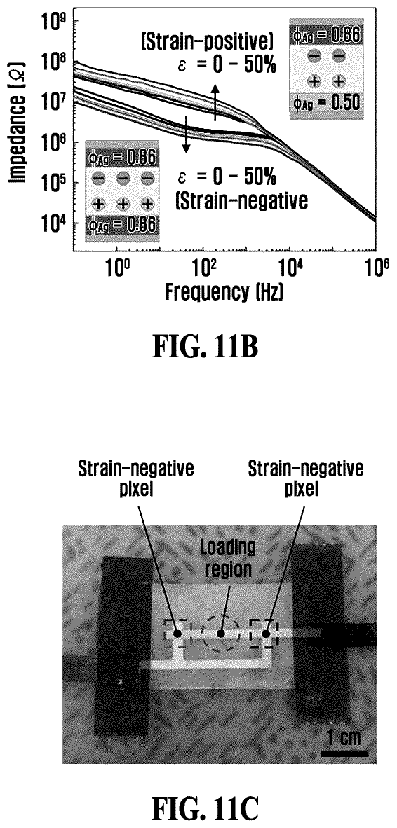

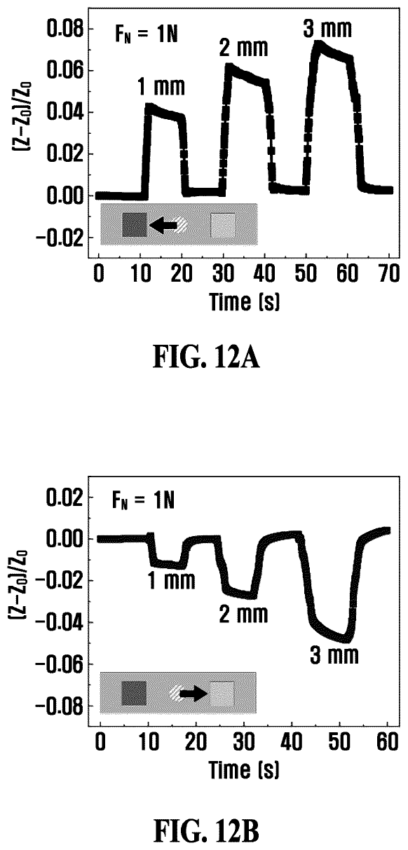

FIGS. 11A to 12B illustrate a direction-discernible shear sensor with two terminals and performance of the direction-discernible shear sensor, according to an embodiment.

FIG. 11A illustrates a configuration of the direction-discernible shear sensor. The direction-discernible shear sensor may include one line of a top electrode and a branched bottom electrode. An ion-gel in which the top electrode and the bottom electrode overlap may function as a pixel. The top electrode had φ_{Ag}=0.86. A left branch of the bottom electrode had φ_{Ag}=0.86 and a right branch of the bottom electrode had φ_{Ag}=0.50. Since a strain response needs to be determined by an electrode with a lower A_{eff}, a pixel formed by the left branch of the bottom electrode was strain-negative, whereas a pixel formed by the right branch of the bottom electrode branch was strain-positive (FIG. 11B). A low-friction interface was introduced by adding baby powder between a shear sensor and a bottom soft substrate to emulate three-dimensional (3D) deformation of the human skin. Edges of the direction-discernible shear sensor were fixed on the soft substrate using a silicon adhesive. Shear forces (F_{S}) were applied by a load cell in opposite directions of target pixels (marked by dotted squares) from a central point (marked by a dotted circle) (FIG. 11C). A fixed normal force (F_{N}=1 N) was simultaneously applied to prevent potential slip between the load cell and the direction-discernible shear sensor. When F_{S} was applied in a direction of the strain-negative pixel, the impedance increased because the strain-positive pixel is strained, and vice versa. Relative impedance changes ((Z−Zₒ)/Zₒ) of the direction-discernible shear sensor at different shear distances (1, 2, and 3 mm) in the direction of the strain-negative (FIG. 12A) and the strain-positive pixel (FIG. 12B) were monitored. A shear speed was 1 mm/s. When F_{S} was applied in the orthogonal (upward or downward) direction, the relative impedance slightly increased due to a strain exerted in the strain-positive pixel.

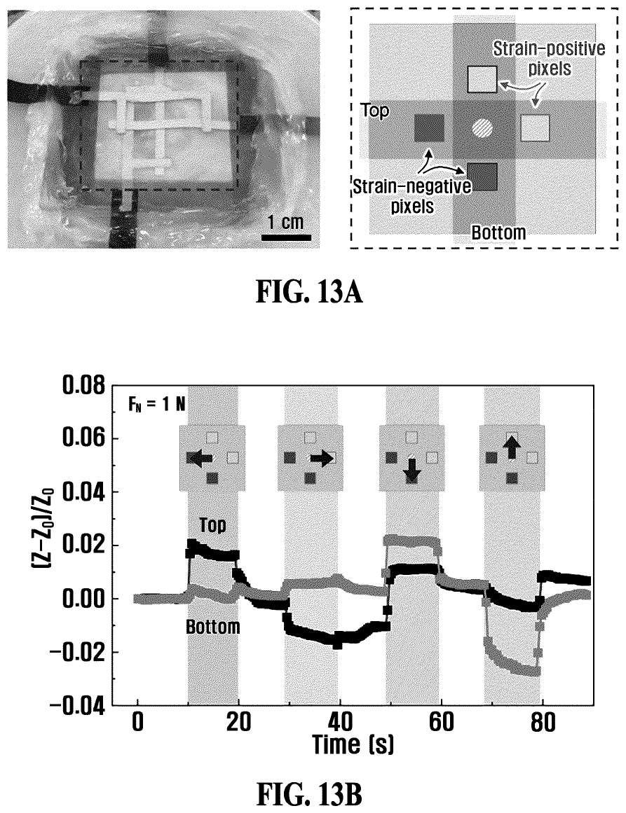

FIGS. 13A and 13B illustrate four-directional shear sensing by stacking two direction-discernible shear sensors according to an embodiment.

A shear sensor recognizing four directions was fabricated by stacking two shear sensors, as illustrated in FIG. 13A; a top sensor with a left (strain-negative) and right (strain-positive) setup, and a bottom sensor with a down (strain-negative) and up (strain-positive) setup. Relative impedance changes from the two sensors provided unique combinations of impedance profiles. The top sensor showed larger impedance changes when a load was moved left (increasing) and right (decreasing), and showed small changes when the load was moved down and up. On the other hand, the bottom sensor showed small changes when the load was moved left and right, and showed larger impedance changes when the load was moved down (increasing) and up (decreasing). A sensor response needs to be closely associated with a modulus of each sensor and a friction force between stacked sensors. Although the above new type of shear sensor needs further sophistication for practical uses, a simple shear sensor design to recognize a shear direction may be provided.

### Conclusions

In an embodiment of the present disclosure, an influence of an electrically-effective surface area of a composite electrode on a strain response in an ion-gel tactile sensor was investigated, and facile designs of the composite electrode to obtain strain-negative, strain-neutral, and strain-positive impedance responses to external stretching was demonstrated. By controlling a fraction of conductive fillers in the composite electrode, the electrically-effective surface area was adjusted. It was revealed that a composite with a large fraction of conductive fillers is strain-negative in impedance, whereas a composite with a small fraction of fillers is strain-positive, and a composite with a moderate fraction of fillers is strain-neutral. The above result may be dependent on whether an electrical connection to a surface decreases (strain-positive), is maintained (strain-neutral), and increases (strain-negative) under stretching. A simple method to guarantee a strain-neutrality by depositing an Au film on the composite electrode and forming a crack was provided. By utilizing an Au crack-based strain-neutral electrode, a strain-independent temperature sensor was demonstrated only by measuring a bulk resistance at a single frequency. In addition, a simple-structured shear sensor was provided by fabricating a two-terminal sensor including a strain-negative device and a strain-positive device. When ion-gel shear sensors are staked, four shear directions may be successfully recognized. One or more embodiments provide a practical strategy to control a strain response of an ion-gel sensor.

While the embodiments are described, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A stretchable composite electrode comprising:
an ion-gel layer;
an upper electrode layer disposed on a top surface of the ion-gel layer; and
a lower electrode layer disposed on a bottom surface of the ion-gel layer,
wherein each of the upper electrode layer and the lower electrode layer comprises a double layer, and a cracked metal layer.

2. The stretchable composite electrode of claim 1, wherein
the ion-gel layer comprises a mixture of an ionic liquid and a polymer binder,
the ionic liquid comprises at least one selected from a group consisting of 1-ethyl-3-methylimidazolium bis(trifluoromethylsulfonyl)imide ([EMIM][TFSI]), 1-butyl-3-methylimidazolium bis(trifluoromethylsulfonyl)imide ([BMIM][TFSI]), 1-butyl-3-methylimidazolium hexafluorophosphate ([BMIM][PF₆]), 1-ethyl-3-methylimidazolium tetrafluoroborate ([EMIM][BF₄]), 1-butyl-3-methylimidazolium tetrafluoroborate ([BMIM][BF₄]), 1-butyl-1-methylpyrrolidinium bis(trifluoromethylsulfonyl)imide ([BMPYR][TFSI]), 1-butyl-1-methylpyrrolidinium tris(pentafluoroethyl)trifluorophosphate ([BMPYR][FAP]), 1-ethyl-3-methylimidazolium tris(pentafluoroethyl)trifluorophosphate ([EMIM][FAP]), 1-ethyl-3-methylimidazolium bis(fluorosulfonyl)imide ([EMIM][FSI]), and ethyl-dimethyl-propylammonium bis(trifluoromethylsulfonyl)imide ([EDMPA][TFSI]), and
the polymer binder comprises at least one selected from a group consisting of poly(vinylidene fluoride-co-hexafluoropropylene) (PVDF-HFP), poly(styrene-block-ethylene oxide-block-styrene (PS-PEO-PS), and poly(styrene-block-methyl methacrylate-block-styrene (PS-PMMA-PS).

3. The stretchable composite electrode of claim 1, wherein the double layer of each of the upper electrode layer and the lower electrode layer comprises a first metal particle/polymer layer and a second metal particle/polymer layer.

4. The stretchable composite electrode of claim 3, wherein
the first metal particle and the second metal particle each have a diameter of 5 micrometers (μm) to 20 μm, and
the first metal particle and the second metal particle each comprise at least one selected from a group consisting of gold (Au), silver (Ag), platinum (Pt), palladium (Pd), copper (Cu), cobalt (Co), zirconium (Zr), zinc (Zn), titanium (Ti), and tin (Sn).

5. The stretchable composite electrode of claim 3, wherein
the first metal particle of the upper electrode layer is in an amount of 75% by weight (wt %) to 80 wt % in the first metal particle/polymer layer,
the second metal particle of the upper electrode layer is in an amount of 67 wt % to 80 wt % in the second metal particle/polymer layer,
the first metal particle of the lower electrode layer is in an amount of 75 wt % to 80 wt % in the first metal particle/polymer layer, and
the second metal particle of the lower electrode layer is in an amount of 67 wt % to 80 wt % in the second metal particle/polymer layer.

6. The stretchable composite electrode of claim 3, wherein the polymer layer comprises at least one selected from a group consisting of polydimethylsiloxane (PDMS), styrene-ethylene-butylene-styrene (SEBS) block copolymer rubber, styrene-isoprene-styrene (SIS) block copolymer rubber, styrene-butadiene-styrene (SBS) block copolymer rubber, polyisoprene rubber, styrene-butadiene (SB) block copolymer rubber, styrene-isoprene (SI) block copolymer rubber, styrene-isoprene-butadiene-styrene (SIBS) block copolymer rubber, styrene-ethylene-propylene-styrene (SEPS) block copolymer rubber, and styrene-ethylene-propylene (SEP) block copolymer rubber.

7. The stretchable composite electrode of claim 1, wherein
the cracked metal layer comprises at least one selected from a group consisting of gold (Au), silver (Ag), platinum (Pt), palladium (Pd), copper (Cu), cobalt (Co), zirconium (Zr), zinc (Zn), titanium (Ti), and tin (Sn), and
the cracked metal layer has a thickness of 45 nanometers (nm) to 100 nm.

8. The stretchable composite electrode of claim 1, wherein
each of the upper electrode layer and the lower electrode layer further comprises an elastic substrate, and
the elastic substrate of each of the upper electrode layer and the lower electrode layer comprises at least one selected from a group consisting of polydimethylsiloxane (PDMS), a fluoroelastomer, a poly(vinylidene fluoride-co-hexafluoropropylene) copolymer, thermosetting polyurethane, silicone, Ecoflex, and Dragon skin.

9. The stretchable composite electrode of claim 1, wherein
when an amount of metal particles in the first metal particle/polymer layer is less than 75 wt %, the stretchable composite electrode has an impedance of 10⁶ ohms (Ω) to 10⁷ Ω in a frequency range of 10⁰ hertz (Hz) to 10² Hz,
when the amount of the metal particles in the first metal particle/polymer layer is greater than or equal to 75 wt % and less than or equal to 80 wt %, the impedance of 10⁶ Ω to 10⁷ Ω is maintained in the frequency range of 10⁰ Hz to 10² Hz, and
when the amount of the metal particles in the first metal particle/polymer layer exceeds 80 wt %, the impedance is in a range of 10⁶ Ω to 10⁹ Ω in the frequency range of 10⁰ Hz to 10² Hz.

10. The stretchable composite electrode of claim 1, wherein, when a strain of 10% to 60% is obtained in a strain-positive response and a strain-negative response, a variation in an impedance of the stretchable composite electrode is similar to a strain-neutral change in a frequency range of 10⁰ Hz to 10⁶ Hz.

11. A method of preparing a stretchable composite electrode, the method comprising:
preparing an upper electrode layer and a lower electrode layer;
forming an ion-gel layer on each of the upper electrode layer and the lower electrode layer; and
arranging the ion-gel layer of the upper electrode layer and the ion-gel layer of the lower electrode layer to face each other and performing a heat treatment.

12. The method of claim 11, wherein the preparing of the upper electrode layer and the lower electrode layer comprises:
forming a sacrificial layer on a substrate;
forming a double layer after placing a pattern mask on the sacrificial layer;
heat-treating the double layer after removing the pattern mask;
coating the heat-treated double layer with an elastic polymer;
forming an elastic substrate by curing the elastic polymer;
separating the substrate by removing the sacrificial layer;
forming a metal layer on the double layer; and
forming a crack in the metal layer by stretching the metal layer.

13. The method of claim 12, wherein the forming of the sacrificial layer on the substrate comprises applying at least one solution selected from a group consisting of polyacrylic acid (PAA), polyvinylpyrrolidone (PVP), dextran, poly(methyl methacrylate) (PMMA), and poly(vinyl alcohol) (PVA) onto the substrate by spin coating, and performing a heat-treatment at a temperature of 80° C. to 150° C. for 10 minutes to 60 minutes, to form the sacrificial layer.

14. The method of claim 12, wherein the forming of the double layer comprises:
forming a first metal particle/polymer layer by applying a first metal particle/polymer ink, obtained by mixing a first metal particle and a polymer, by blade coating;
plasma-treating a surface of the first metal particle/polymer layer; and
forming a second metal particle/polymer layer by applying a second metal particle/polymer ink, obtained by mixing a second metal particle and a polymer, onto the plasma-treated surface of the first metal particle/polymer layer, by blade coating.

15. The method of claim 14, wherein the plasma-treating of the surface of the first metal particle/polymer layer comprises performing an oxygen plasma treatment in a power range of 80 watts (W) to 120 W at an oxygen flow rate of 30 standard cubic centimeters per minute (sccm) to 50 sccm for 1 second to 300 seconds.

16. The method of claim 12, wherein the heat-treating of the double layer comprises heat-treating the double layer under a vacuum condition in a temperature range of 100° C. to 200° C. for 1 hour to 6 hours.

17. The method of claim 12, wherein the separating of the substrate, on which the double layer is formed, comprises immersing the substrate in deionized water in a temperature range of 20° C. to 100° C. for 30 minutes to 300 minutes and removing the sacrificial layer, to separate the substrate.

18. The method of claim 12, wherein the forming of the crack in the metal layer by stretching the metal layer comprises repeatedly performing 5 to 20 times a pre-process of applying and releasing stretching in a range of 30% to 80% after a deposition of the metal layer.

19. The method of claim 12, further comprising, after the forming of the crack in the metal layer by stretching the metal layer:
forming an elastic substrate on the metal layer with the crack,
wherein the forming of the elastic substrate comprises applying the elastic polymer by spin coating, and performing annealing in a temperature range of 20° C. to 100° C. for 30 minutes to 300 minutes.

20. A temperature sensor comprising the stretchable composite electrode of claim 1.
